(19) United States
(12) Patent Application Publication
(10) Pub. No.: US 2024/0163939 A1
(43) Pub. Date: May 16, 2024

(54) PEER GROUPING FOR MULTI-LINK OPERATIONS

(71) Applicant: Cisco Technology, Inc., San Jose, CA (US)

(72) Inventors: John M. SWARTZ, Lithia, FL (US); Malcolm M. SMITH, Richardson, TX (US); Robert E. BARTON, Richmond (CA); Matthew A. SILVERMAN, Shaker Heights, OH (US)

(21) Appl. No.: 18/193,472

(22) Filed: Mar. 30, 2023

Related U.S. Application Data
(60) Provisional application No. 63/383,402, filed on Nov. 11, 2022.

(51) Int. Cl. H04W 76/14; H04W 74/04

(52) U.S. Cl. CPC H04W 76/14; H04W 74/04

(57) ABSTRACT

Techniques for improved peer-to-peer grouping in multi-link operations are provided. An indication of radio frequency (RF) capabilities of a peer-to-peer device is transmitted, and the peer-to-peer device receives a group ID assigned by a wireless access point (AP) based on the RF capabilities, where the group ID is associated with a set of links that can be used for peer-to-peer communications between peer-to-peer devices in a first group of peer-to-peer devices. The peer-to-peer device can request that the AP schedule a transmission opportunity for a first peer-to-peer communication using the group ID. In response to receiving a trigger frame comprising the group ID, the first peer-to-peer device performs the first peer-to-peer communication using the transmission opportunity.

### CROSS-REFERENCE TO RELATED APPLICATIONS

This application claims benefit of co-pending U.S. provisional patent application Ser. No. 63/383,402 filed Nov. 11, 2022. The aforementioned related patent application is herein incorporated by reference in its entirety.

### TECHNICAL FIELD

Embodiments presented in this disclosure generally relate to peer-to-peer communications. More specifically, embodiments disclosed herein relate to grouping peers in multi-link systems.

### BACKGROUND

In a variety of telecommunications systems, participating devices on either end of a transmission are sometimes capable of using multiple connections or links (either in the alternative or in combination). A link can generally be any connection between nodes or points in the network, including wired, wireless, or a combination of wired and wireless links, such as between communicating devices (e.g., two client devices), between an access point and a client device, and the like. Such technology may be referred to as multi-link operations (MLO). There are a variety of categories or types of multilink devices (MLDs), including those that can transmit and receive data simultaneously on different links (e.g., simultaneous transmit/receive (STR) MLDs), those that can transmit and receive on different links non-simultaneously (e.g., non-simultaneous transmit/receive (NSTR) MLDs), and those that use a single radio to provide multiple links (e.g., enhanced multi-link single-radio (eMLSR) MLDs).

In peer-to-peer (P2P) and/or client-to-client (C2C) communications, the communicating peers generally use various wireless resources to communicate with each other. In many cases, one or more of the communicating peers also separately communicates with an access point (AP) for broader network connectivity.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment for use of peer grouping for enhanced peer-to-peer communications using MLO, according to some embodiments of the present disclosure.

FIG. 2 is a flow diagram depicting an example method for implementing peer groups to perform enhanced peer-to-peer communication using MLO, according to some embodiments of the present disclosure.

FIG. 3 is a flow diagram depicting an example method for requesting peer group transmission opportunities, according to some embodiments of the present disclosure.

FIG. 4 is a flow diagram depicting an example method for performing peer-to-peer communications in a peer group using MLO, according to some embodiments of the present disclosure.

FIG. 5 is a flow diagram depicting an example method for allocating resources for peer-to-peer group communications, according to some embodiments of the present disclosure.

FIG. 6 is a flow diagram depicting an example method for performing peer-to-peer group communications, according to some embodiments of the present disclosure.

FIG. 7 depicts an example computing device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including transmitting, by a first peer-to-peer device, an indication of radio frequency (RF) capabilities of the first peer-to-peer device; receiving, by the first peer-to-peer device, a group ID assigned by a wireless AP based on the RF capabilities, wherein the group ID is associated with a set of links that can be used for peer-to-peer communications between peer-to-peer devices in a first group of peer-to-peer devices; requesting, by the first peer-to-peer device, that the AP schedule a transmission opportunity for a first peer-to-peer communication using the group ID; and in response to receiving a trigger frame comprising the group ID, performing the first peer-to-peer communication using the transmission opportunity.

Other embodiments in this disclosure provide non-transitory computer-readable mediums containing computer program code that, when executed by operation of one or more computer processors, performs operations in accordance with one or more of the above methods, as well as systems comprising one or more computer processors and one or more memories containing one or more programs which, when executed by the one or more computer processors, performs an operation in accordance with one or more of the above methods.

### EXAMPLE EMBODIMENTS

Embodiments of the present disclosure provide techniques and technologies for enhanced MLO and peer-to-peer communication using peer groupings.

Generally, a variety of devices can establish and use multiple links (in MLO). Some standards, such as WiFi7/11 be, define a MLD in a way that requires all links of the MLD to terminate/originate from the same media access control (MAC) layer entity (identified by a virtual MLD address). That is, in conventional standards, the MAC protocol data unit (MPDU) processing (e.g., acknowledgement (ACK) generation and score boarding) must be the same entity for all links of the MLD.

In some embodiments of the present disclosure, this requirement (that all links terminate at the same entity) can be relaxed, enabling the individual links of the MLD to terminate on different MAC entities. For example, in some embodiments, one MAC entity (where one link terminates) may be a peer of a non-AP device (e.g., for peer-to-peer communications), and a second MAC entity (where a second link terminates) may be an AP that has no MAC layer relationship with the peer. This ability to maintain MLO links to separate MAC entities can enable substantial new capabilities for the devices. In some embodiments of the present disclosure, though the strict definition of an MLD may differ from conventional standards, the systems can exploit the underlying nature of the Wi-Fi7 MLDs, including the class of device (e.g., STR, NSTR, eMLSR, and the like) and respective simultaneous operation behaviors and channel separation requirements in order to provide enhanced communication, as discussed in more detail below.

In some embodiments, to enhance peer-to-peer communications in MLO environments, peer groups can be discovered or established for AP-coordinated communication. That is, in systems where the AP allocates resources (e.g., resource units (RUs)) for P2P communication among peers, the peers may form a group that enables group-based allocations and scheduling/triggering.

In some embodiments, peer devices can report their capabilities (e.g., channels they can use, STR or NSTR MLO capability, and the like) and/or AP visibility (e.g., which APs each can see) to a director or leader of the group. In an embodiment, this director can aggregate these reports to identify a subset of AP(s) and/or link(s) or channel(s) for the group, and request (e.g., from the subset of AP(s)) to establish an MLO link set corresponding to this subset of links/channels. Additionally, in an embodiment, the AP(s) can establish a group identifier (ID) for the group. Subsequently, when peer-to-peer communications are desired or needed, the director (or another entity) can request a transmission opportunity using the group identifier, rather than using a specific MAC address and/or association ID. That is, while conventional devices request transmit opportunities (TXOPs) (also referred to in some embodiments as transmission opportunities) and includes its own identifier (indicating that the requested TXOP will be used by the device), in some embodiments of the present disclosure, the TXOPs can be requested while specifying the group ID (e.g., indicating that the requested TXOP will be used by the group, without actually identifying or indicating any specific device in the group).

In some embodiments, the AP(s) can thereby allocate or schedule resources (e.g., RUs) during one or more TXOPs to the group. When peer devices in the group see this scheduling (e.g., when the scheduling frame(s) indicate that one or more RUs/sub-channels are allocated to the group ID), the peers can listen for the subsequent trigger. When the trigger (indicating the group ID and/or allocated TXOP) arrives, the group of peers can engage in peer-to-peer communication using the scheduled resources. In some embodiments, the coordination as to which peer device in the group actually uses each allocated TXOP/RU(s) can be determined using a variety of criteria or techniques, such as selected by the director device, determined based on priority, and the like.

In this way, the peer devices can leverage MLO communication among the peers in the group as well as with the AP, allowing for more flexible and efficient scheduling of the resources (e.g., using the group identifier) as well as more flexible and efficient communication among the peer-to-peer devices.

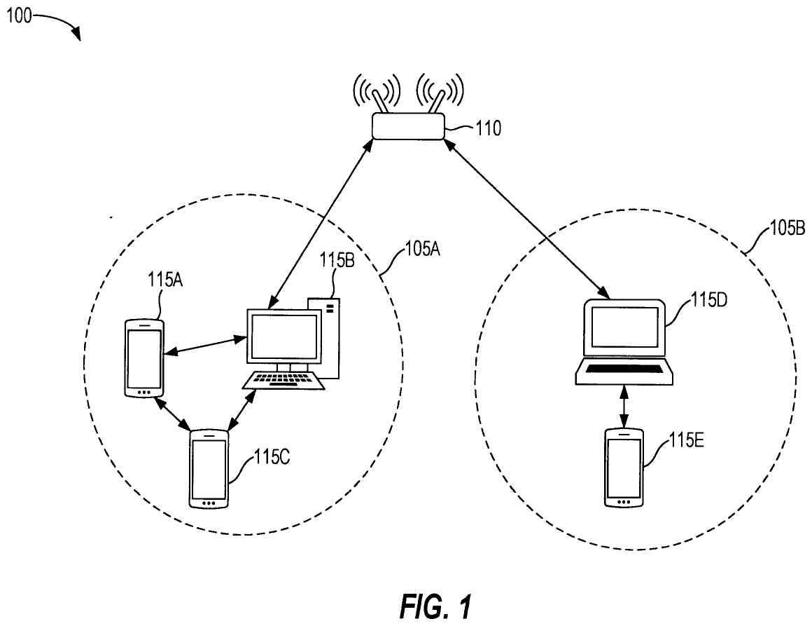

FIG. 1 depicts an example environment 100 for use of peer grouping for enhanced peer-to-peer communications using MLO, according to some embodiments of the present disclosure.

The illustrated environment 100 includes an AP 110 and a number of peer-to-peer devices 115A-E (collectively, peer-to-peer devices 115). Although a single AP 110 is depicted for conceptual clarity, in embodiments, there may be any number of APs 110. Additionally, there may similarly be any number of peer-to-peer devices 115. The peer-to-peer devices 115 may include a variety of devices, such as smartphones, laptops, desktop computers, and the like.

In some embodiments, the peer-to-peer devices 115 may each be MLO-capable, in that they are capable of establishing and using multiple links for communication (e.g., a first link in the 2.4 GHz band, a second in the 5 GHz band, and a third in the 6 GHz band). The number of links supported by each peer-to-peer devices 115 may vary depending on the particular implementation. As discussed above, in conventional systems, all links on any given MLD must terminate at the same MAC entity. For example, peer-to-peer device 115A and peer-to-peer device 115C may have a set of links between them, but neither can simultaneously have a link to other devices. In the illustrated environment, as discussed above, this requirement may be relaxed such that the peer-to-peer devices 115 can establish and maintain MLO links to different entities.

For example, in the illustrated environment 100, the peer-to-peer device 1158 may establish one of its MLO links to the AP 110, a second MLO link to the peer-to-peer device 115A, and a third MLO link to the peer-to-peer device 115C.

In the illustrated example, the peer-to-peer devices 115 are clustered or grouped into two peer groups 105A and 105B. Specifically, the peer-to-peer devices 115A, 115B, and 115C are included in a first peer group 105A, and the peer-to-peer devices 115D and 115E are included in a second peer group 1058. Although two peer groups 105 are depicted for conceptual clarity, in embodiments, there may be any number of peer groups (each with any number of peer-to-peer devices 115).

Generally, the peer groups 105 may be used to enable flexible and efficient peer-to-peer communication among the peer-to-peer devices 115 in the group. In some embodiments the peer-to-peer devices 115 within a given peer group 105 may be unable to communicate directly (e.g., using peer-to-peer techniques) to devices outside of their peer group 105, and such inter-group communications may be made via the AP 110. In other embodiments, the peer-to-peer devices 115 may be able to use direct inter-group communications (e.g., using conventional peer-to-peer scheduling, rather than peer-to-peer group scheduling).

In embodiments, the groups 105 may be established using a variety of techniques. For example, in some embodiments, a user or administrator defines the peer groups 105 (e.g., indicating which group each peer-to-peer device 115 belongs to). In some embodiments, the peer-to-peer devices 115 may group themselves based on various criteria, such as physical proximity to each other (e.g., determined based on perceived signal strength from each other or other location-determination techniques), overlapping capabilities (e.g., where peer-to-peer devices 115 having similar or matching RF capabilities group themselves together), and the like. In some embodiments, the AP 110 may generate the groups 105. For example, each peer-to-peer device 115 may indicate its capabilities or characteristics to the AP 110, allowing the AP 110 to group them appropriately based on the capabilities, location(s) of each device, and the like.

In the illustrated example, each peer group 105 has a corresponding group leader or director. Specifically, the director of the peer group 105A is the peer-to-peer device 1158, and the director of the peer group 1058 is the peer-to-peer device 115D. In some embodiments, any peer-to-peer device 115 may be defined as the director for a given group 105. For example, a user or administrator may select the director, the peer-to-peer devices 115 may elect a director, and the like.

As illustrated, the group director for each peer group 105 may use its MLO capabilities to establish one or more links directly to the AP 110, as well as one or more links to each peer in the group 105. In some embodiments, each other (non-director) peer-to-peer device 115 may establish an MLO link to each other peer in its respective peer group 105. In some embodiments, one or more of the non-director peer-to-peer devices 115 can further establish an MLO link to the AP 110. That is, some non-director peer-to-peer devices 115 may also be associated to the AP 110 and capable of sending and receiving data via the corresponding MLO link to the AP 110.

In some embodiments, some or all of the non-director peer-to-peer devices 115 may lack such formal association to the AP 110. In the illustrated environment 100, even if a given peer-to-peer device 115 is not formally associated to the AP 110, each peer-to-peer device 115 can generally listen to broadcasts from the AP 110. That is, a given peer-to-peer device 115 may lack formal association (e.g., lack an association ID with the AP 110) such that the device may be unable to transmit data to the AP 110. However, each peer-to-peer device 115 may still receive and evaluate frames transmitted by the AP 110 to determine whether they include the group ID of their peer group 105, as discussed below in more detail.

In the illustrated example, when peer-to-peer devices 115 form a peer group 105 (regardless of the presence or association to an AP 110), the peer-to-peer devices 115 can share/indicate their radio frequency (RF)/MLO capabilities to each other. For example, the peer-to-peer devices 115 may indicate their type or category of MLO (e.g., STR, NSTR, eMLSR, and the like). As an additional example, the peer-to-peer devices 115 may indicate their operating channels (e.g., 5 GHz, 2.4 GHz, and the like) as part of their RF capabilities. In some embodiments, the peer-to-peer devices 115 share this information with all other devices in their group 105. In some embodiments, the peer-to-peer devices 115 share this information with the group director.

In some embodiments, in addition to sharing their RF capabilities, the peer-to-peer devices 115 in each group 105 may further share or indicate which AP(s) 110 are nearby/visible. That is, each peer-to-peer device 115 may indicate which AP(s) 110 it can see/receive data from (e.g., which beacon frames it has received in the last sixty seconds or some other period of time). In some embodiments, this can include indicating which visible AP(s) 110 support peer-to-peer scheduling (e.g., Wi-Fi7 trigger-based peer-to-peer TXOP sharing).

In the illustrated environment 100, the director of each group 105 can aggregate or evaluate the indicated RF capabilities and/or AP visibility indicated by the (subordinate) peer-to-peer devices 115 in the group 105, along with its own capabilities and visibility. This can allow the director peer-to-peer device 115 to select one or more APs 110 to support the group 105. For example, based on the list of the APs 110 that support peer-to-peer scheduling, along with their operating channels and estimates of received signal strength indicators (RSSI) and/or channel load of each AP 110, the director may identify those APs 110 that are common to the group 105 (e.g., AP(s) 110 that are visible to all peers in the group 105 and supporting one or more channels that all peers in the group 105 can utilize, such as P20).

In some embodiments, the director peer-to-peer device 115 can select a set of one or more AP channels that have good RSSI to the director itself as well as to each of the subordinate peer-to-peer devices 115 in the group 105. For example, the director may identify channel(s) with RSSI above a threshold to each peer-to-peer device 115. In some embodiments, the director peer-to-peer device 115 may further select the channels based on traffic or channel utilization (CU) over time (e.g., over the last sixty seconds or longer). That is, the director may select channel(s) with the lowest traffic/CU over the window.

Although a single AP 110 is illustrated in the depicted environment 100, as discussed above, there may be multiple APs 110 in some embodiments. In one such embodiment, the channel(s) selected by the director peer-to-peer device 115 may be with respect to a single AP 110, or may be across multiple APs.

In an embodiment, the director peer-to-peer device 115 can then request that the AP 110 (or group of APs) establish a set of links (referred to in some aspects as a P2P MLO link set) within the selected channel(s) of the AP 110 (e.g., a channel in each band, such as 2.4 GHz, 5 GHz, and/or 6 GHz). That is, the director peer-to-peer device 115 can request that the AP 110 establish or define a set of channel(s) that the peers can use to connect to each other and/or the AP 110 (e.g., to scan/detect traffic on the links). This allows the peer-to-peer devices 115 to identify resource allocations, as discussed above.

In some embodiments, the AP 110 can then reject or accept the request. If accepted, the AP 110 can establish a group ID for the MLO link set and/or for the group 105. As discussed above and in more detail below, the group ID can be used subsequently for scheduling peer-to-peer TXOPs that can be used by the group in lieu of using specific MAC address or association IDs to schedule peer-to-peer communication. In some embodiments, it should be noted that the P2P MLO link set can be formed by the AP 110 regardless of the APs own MLD capability (if any), as the peer-to-peer devices 115 use MLO among themselves and need not necessarily use MLO to communicate with the AP as well.

In some embodiments, the director peer-to-peer device 115 can communicate to each AP the list of APs selected for the MLO link set for the group 105. The AP(s) may then coordinate the group ID across all participating APs. In some such embodiments, this group ID can be used as a scheduling reference across multiple APs serving the group 105.

In an embodiment, if the request is accepted by the AP 110, the director peer-to-peer device 115 can communicate or indicate, to each member peer-to-peer device 115 in the group 105, which channel(s) will be used for MLO operation between the peers.

In an embodiment, the group directors can then manage peer-to-peer communications for their respective groups 105. For example, the director peer-to-peer device 115 may know the MLO capability of each peer (e.g., STR, NSTR, or eMLSR), as well as the traffic demands or needs (e.g., traffic class/traffic ID, load, etc.) of the peer-to-peer devices 115. The director may therefore request transmission opportunities (e.g., TXOPs) from the AP(s) 110 (e.g., using Wi-Fi7 stream classification service (SCS) and/or quality of service (QoS) signaling, including per-TID peer-to-peer reservations, period/scheduling intervals, and the like) for a compatible scheduling.

In some embodiments, the particular scheduling requested by the director may vary depending on the RF/MLO capabilities of the peer-to-peer devices 115 in the group 105. For example, in one embodiment, if all of the peer-to-peer devices 115 in the group 105 (or within a subgroup, of the group 105, that will use the TXOP) are STR devices (e.g., devices that can transmit and receive simultaneously on all links), the director may request a TXOP on all links of the P2P MLO link set at the same time (e.g., for full MLO simultaneity).

As another example, in some embodiments, if all of the peer-to-peer devices 115 in the group 105 (or within a subgroup, of the group 105, that will use the TXOP) are eMLSR devices (e.g., devices that have a selectable single-link duplex/single radio), the director may request a TXOP on a single preferred link of the link set. For example, the director may identify the preferred link based on RSSI (e.g., identifying the link with the highest RSSI), CU (e.g., identifying the link with the lowest CU), and the like.

As yet another example, in some embodiments, if all of the peer-to-peer devices 115 in the group 105 (or within a subgroup, of the group 105, that will use the TXOP) are NSTR devices (e.g., devices that cannot simultaneously send and receive data on multiple links), the director may request a TXOP on all links of the link set (e.g., for fully simultaneous use). However, the director may ensure that the TXOP duration requested from the AP 110 is the same on each link in the link set to ensure each peer can align the physical packet data units (PPDUs) end time on each link. That is, the director can request TXOPs on each link with a matching duration to ensure that the PPDUs sent on each link in the set end at the same time, to enable the NSTR communication.

In some embodiments, the director peer-to-peer device 115 of each group 105 can itself allocate time in the TXOP for both the PPDU(s) and ACK(s), if needed.

In an embodiment, when the TXOP is successfully scheduled by the AP(s) 110 across the link set, the AP 110 can return or transmit a scheduling or allocation frame (e.g., an SCS response). In some embodiments, the group ID specified in this response indicates the RUs/sub-channels allocated, as well as duration of each TXOP. In some embodiments, this scheduling is communicated directly to the peer-to-peer devices 115. For example, as each peer-to-peer device 115 may listen to frames transmitted by the AP 110, each peer-to-peer device 115 may be able to identify the use of their group ID and thereby determine their allocated resources. In some embodiments, the scheduling may be forwarded or indicated to the peer-to-peer devices 115 by the director.

In some embodiments, once the TXOP assignment/allocation arrives, the peer-to-peer devices 115 can listen for the peer-to-peer trigger that includes the group ID on the expected RU(s), and transmit according to any peer-to-peer TXOP rules. As discussed above, the particular coordination as to which peer-to-peer device(s) 115 in the group 105 actually uses the TXOP can be determined using a variety of techniques.

Although the illustrated example depicts existing peer groups 105, in some embodiments, the AP 110 may itself define the groups, as discussed above. For example, rather than having a-priori groups and/or directors, each peer-to-peer device 115 may request membership in a peer-to-peer MLO group (e.g., from the AP 110), and the AP 110 (or other network infrastructure) may define the groups, assign group IDs, and schedule the TXOPs accordingly. For example, each peer-to-peer device 115 may use SCS or other techniques to indicate traffic needs and/or to request MLO peer-to-peer scheduling, and the AP 110 (or other entity, such as a controller) can consolidate these requests from multiple peer-to-peer devices 115 to form scheduling groups as discussed above (e.g., to ensure that peers in the same group have similar RF capabilities, similar AP visibility, and the like). This may reduce or eliminate any overhead of group election and TXOP coordination.

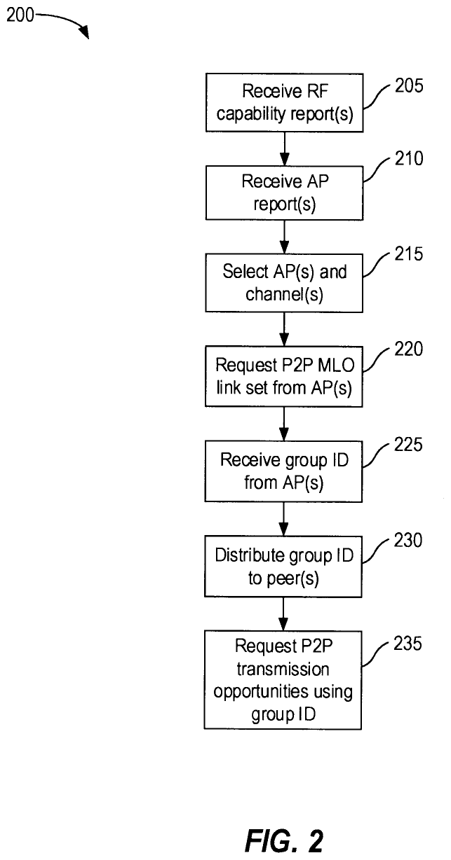

FIG. 2 is a flow diagram depicting an example method 200 for implementing peer groups to perform enhanced peer-to-peer communication using MLO, according to some embodiments of the present disclosure. In some embodiments, the method 200 is performed by a peer-to-peer device, such as a peer-to-peer device 115 of FIG. 1. In some embodiments, the method 200 is performed by a director peer-to-peer device.

At block 205, the peer-to-peer device receives one or more RF capability reports from one or more peer devices. For example, as discussed above, each peer-to-peer device may share its RF capabilities with the director of the peer group (or with all other device(s) in the peer group). That is, in some embodiments, the peer-to-peer devices exchange RF capability information with each other regardless of which device is the director (if one has been selected). In some embodiments, the devices select the director based at least in part on information such as relative priority of each device, capabilities or capacity of each, and the like.

As discussed above, the RF capability reports can generally indicate the characteristics or capabilities of the peer-to-peer device that provided the report. For example, the RF capabilities may indicate which MLO technologies the device supports (e.g., STR, NSTR, eMSLR, and the like), the number of links the device can support, the channels or frequency bands that the device supports (e.g., indicating it can establish links in the 2.4 GHz band, the 5 GHz band, and the like), and the like.

At block 210, the peer-to-peer device receives one or more AP reports from one or more peer devices. For example, as discussed above, each peer-to-peer device may share a list of the AP(s) it can see (e.g., the AP(s) from which the device received one or more beacons within a defined timeframe). In some embodiments, the AP report(s) can also indicate other relevant information, such as the RSSI of each AP (e.g., the signal strength from each AP, as perceived by the device that provided the AP report), the capabilities of each AP (e.g., whether the AP supports peer-to-peer scheduling), and the like.

At block 215, the peer-to-peer device selects one or more APs and one or more channels based on the received information. For example, as discussed above, the peer-to-peer device may select one or more APs based on the AP reports, such as to select AP(s) that are visible to all peers in the group, to select AP(s) having a minimum signal strength to all peers in the group, and the like.

In some embodiments, the peer-to-peer device can further select the AP(s) based on information such as their operating channels (e.g., to ensure that the selected AP serves channel(s) that all of the peers can utilize), channel load (e.g., to select AP(s) having the minimum CU), and the like.

In some embodiments, the peer-to-peer device selects the channel(s) based on the received RF capability information. For example, as discussed above, the peer-to-peer device may select a set of channel(s) that each peer in the group can support, select a channel that has a sufficiently strong RSSI to each peer from the AP, to select a channel having low traffic/utilization (e.g., over the last sixty seconds), and the like. As discussed above, the peer-to-peer device may select one or more channels across one or more APs.

At block 220, the peer-to-peer device requests a P2P MLO link set for the selected channel(s) from the selected AP(s). That is, the peer-to-peer device requests that the AP(s) establish a link set, the link set corresponding to a subset of the frequencies or channels that the AP supports (e.g., the subset(s) that the peer devices can all use and/or all have links established on).

At block 225, the peer-to-peer device receives, from the AP(s), a group ID for the peer group. As discussed above, this group ID may be used when scheduling or requesting resources, rather than a unique/individual identifier of any specific device. That is, the peer-to-peer device may request resource allocation for the group ID on behalf of the group, rather than specifically identifying which device will use the resources. In some embodiments, this can allow devices to be scheduled by the AP while remaining anonymous to it. That is, because subordinate peers in the group need not directly transmit data to the AP and the director can request resource allocations for use by any devices in the group, the subordinate peers can receive scheduled RUs and other resources without the AP identifying the subordinate itself.

At block 230, the peer-to-peer device distributes the received group ID among the peer(s) in the group. For example, the peer-to-peer device may use one or more out of band (00B) techniques such as Bluetooth to distribute the group ID.

At block 235, the peer-to-peer device can then request peer-to-peer transmission opportunities using the group ID. That is, the director can request wireless resources to be used for peer-to-peer communication by any device(s) in the group, and need not explicitly identify the device(s) that will use the resources. This can improve the flexibility and efficiency of the peer-to-peer communications within the group.

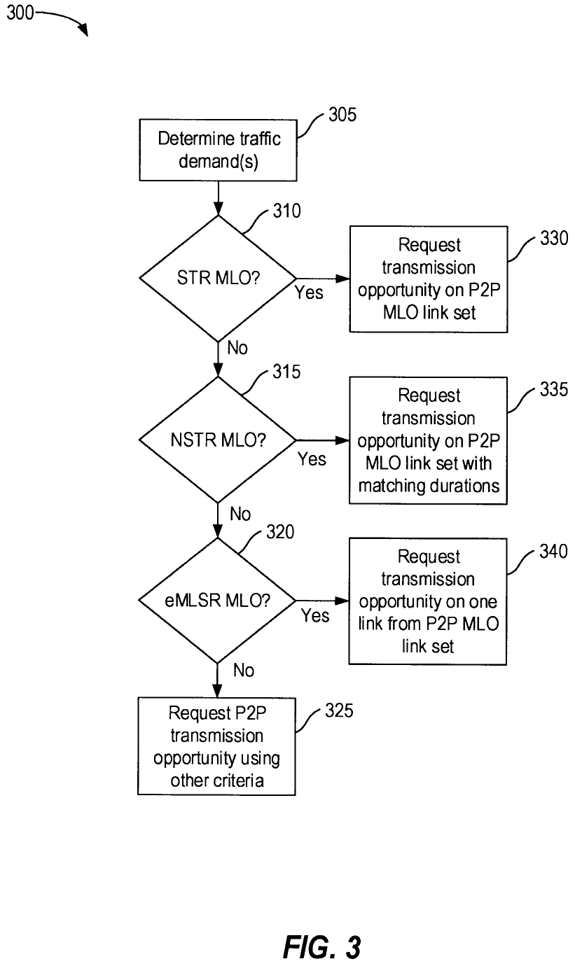

FIG. 3 is a flow diagram depicting an example method 300 for requesting peer group transmission opportunities, according to some embodiments of the present disclosure. In some embodiments, the method 300 is performed by a peer-to-peer device, such as a peer-to-peer device 115 of FIG. 1. In some embodiments, the method 200 is performed by a director peer-to-peer device. In at least one embodiment, the method 300 provides additional detail for block 235 of FIG. 2.

At block 305, the peer-to-peer device determines traffic demands/needs for its group of peer-to-peer devices. For example, as discussed above, the peer devices may share or exchange information relating to their peer-to-peer data transmission desires, such as QoS data, SCS data, the amount of data they want to send to peer(s), the timing of the data (e.g., for periodic data), and the like. In some embodiments, as discussed above, the peer-to-peer device also determines the RF and/or MLO capabilities of each peer (e.g., the type of MLO that each supports).

At block 310, the peer-to-peer device determines whether all of its peers in the group (or all of the peers that wish to transmit data during the upcoming transmission opportunity) support STR MLO. If so, the method 300 continues to block 330, and the peer-to-peer device requests one or more transmission opportunities (e.g., from the AP(s) to which the peer-to-peer device is associated) using all links in the previously established P2P MLO link set, as discussed above. That is, because all peers are STR devices (and can transmit/receive simultaneously on multiple links), the peer-to-peer device may request that the transmission opportunity include RUs on all of the links, such that all may be used during the opportunity.

If, at block 310, the peer-to-peer device determines that at least one peer (or at least one peer that wishes to transmit data) does not support STR MLO, the method 300 continues to block 315, where the peer-to-peer device determines whether all of the peer devices (or all of the peers that wish to transmit data during the transmission opportunity) support NSTR MLO. In some embodiments, the peer-to-peer device can alternatively determine whether all of the devices support either STR MLO or NSTR MLO. That is, if some of the peers support STR MLO and some support NSTR MLO, the peer-to-peer device may determine that NSTR MLO should be used.

If, at block 315, the peer-to-peer device determines to use NSTR MLO, the method 300 continues to block 335, where the peer-to-peer device requests one or more transmission opportunities (e.g., from the AP(s) to which the peer-to-peer device is associated) using all links in the previously established P2P MLO link set, but with a matching duration on each link, as discussed above. That is, because at least some of the peers are NSTR devices (and cannot transmit/receive simultaneously on multiple links), the peer-to-peer device may request that the transmission opportunity include RUs on all of the links, such that all may be used during the opportunity, but with matching durations on all links, to ensure that the PPDUs on each link end at the same time. This allows for NSTR MLO.

If, at block 315, the peer-to-peer device determines that at least one peer (or at least one peer that wishes to transmit data during the opportunity) is not an NSTR MLO device, the method 300 continues to block 320, where the peer-to-peer device determines whether all of the peer devices (or all of the peers that wish to transmit data during the transmission opportunity) support eMLSR. In some embodiments, the peer-to-peer device can alternatively determine whether all of the devices support either STR MLO, NSTR MLO, or eMLSR MLO. That is, if some of the peers support STR MLO and/or NSTR MLO and some support eMLSR, the peer-to-peer device may determine that eMLSR MLO should be used.

If, at block 320, the peer-to-peer device determines to use eMLSR MLO, the method 300 continues to block 340, where the peer-to-peer device requests one or more transmission opportunities on a single link from the previously established P2P MLO link set. That is, because all (or at least one) peer can only use one link at a time, the peer-to-peer device can determine to request a transmission opportunity on a single link. In some embodiments, as discussed above, the peer-to-peer device can request a transmission opportunity on a selected or preferred link (e.g., the link having the lowest utilization), as discussed above.

If at block 320, the peer-to-peer device determines not to use eMLSR MLO (e.g., because at least one peer in the group does not support it), the method 300 continues to block 325, where the peer-to-peer device can request one or more transmission opportunities using other criteria/technologies (e.g., different parameters) depending on the particular capabilities of the peer(s).

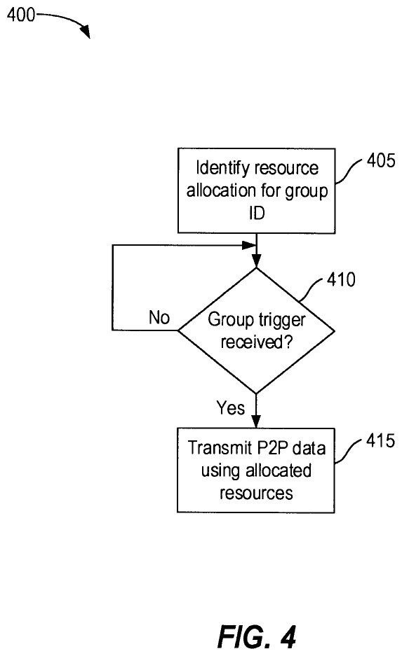

FIG. 4 is a flow diagram depicting an example method 400 for performing peer-to-peer communications in a peer group using MLO, according to some embodiments of the present disclosure. In some embodiments, the method 400 is performed by a peer-to-peer device, such as a peer-to-peer device 115 of FIG. 1. In some embodiments, the method 400 may be performed by a director peer-to-peer device and/or by a subordinate peer-to-peer device.

At block 405, the peer-to-peer device identifies a resource allocation for its peer group based on the group ID of the group. For example, as discussed above, the AP may broadcast frames indicating allocations (e.g., mapping IDs to RUs/subcarriers). For conventional devices, the allocation can indicate allocation of an RU to a specific device (e.g., using the device's association ID, MAC address, and the like). In the illustrated example, however, the message indicates allocation of the RU(s) to the group ID without specifically identifying any individual peer in the group.

At block 410, the peer-to-peer device determines whether the trigger has been received from the AP. That is, the peer-to-peer device determines whether the AP has broadcast a trigger frame that includes the group ID. If not, the method 400 iterates at block 410 until the trigger is seen.

If, at block 410, the peer-to-peer device determines that the trigger has been sent, the method 400 continues to block 415, where the peer-to-peer device transmits peer-to-peer data using the allocated resources (determined at block 405) during the transmission opportunity. In some embodiments, as discussed above, the particular techniques used to determine which peer(s) in the group should use a given transmission opportunity may vary depending on the particular implementation. For example, in at least one embodiment, the director peer may indicate which peer(s) should use the allocated resources when the trigger frame is received.

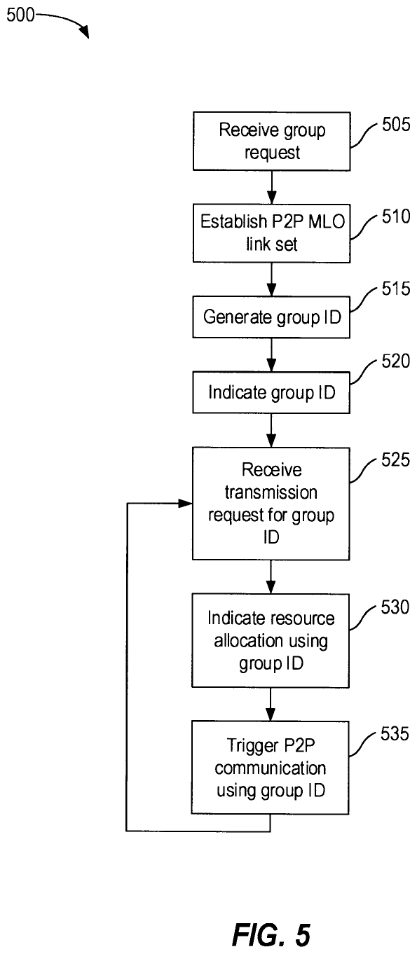

FIG. 5 is a flow diagram depicting an example method 500 for allocating resources for peer-to-peer group communications, according to some embodiments of the present disclosure. In some embodiments, the method 500 is performed by an AP, such as AP 110 of FIG. 1.

At block 505, the AP receives a group request from a peer-to-peer device. For example, as discussed above, the request may be received from a device acting as a director for a group of peer-to-peer devices. In some embodiments, the group request includes a request for the AP to establish a link set and assign a group ID to the group. In at least one embodiment, the request is transmitted by a non-director device and includes a request to add the device to a group (e.g., to add them to an existing group, or to establish a new group that includes the device).

At block 510, the AP establishes a P2P MLO link set for the group of peer-to-peer devices. In some embodiments, as discussed above, the link set is established based on capabilities/preferences indicated in the group request. That is, the peer-to-peer device may indicate the channel(s) or frequency band(s) that it would prefer to use and/or is capable of using for peer-to-peer communications. In one embodiment, the AP establishes the link set by selecting one or more channels in each indicated band of frequencies (e.g., one in the 2.4 GHz band, one in the 5 GHz band, and one in the 6 GHz band).

At block 515, the AP generates a group ID for the group. Generally, the group ID can be generated using any techniques, including randomly or pseudo-randomly. The group ID can generally include any identifier that can be used to identify the group, such as an assigned number. In some embodiments, the group ID is generated in a similar manner to the generation of association IDs when client devices associate to the AP. That is, the group ID can effectively be used as an association ID for the group of devices.

At block 520, the AP indicates or returns the group ID (and an indication of the link set, in some embodiments) to the device that requested the group to be established. In some embodiments, if the requesting device is a director device,

At block 525, the AP receives a transmission request from a peer-to-peer device, where the request specifies a group ID rather than an association ID or MAC address. For example, the request may be a request for wireless resources (e.g., one or more RUs) during one or more transmission opportunities. By including the group ID, the request indicates that the requested resources will be used by one or more devices in the group, rather than specifically identifying which device will use the resources, when allocated.

At block 530, the AP allocates resources for the group based on the request, and indicates the allocated resources using the group ID. For example, as discussed above, the AP may broadcast a frame indicating RU allocations (e.g., a request to send (RTS) frame and/or a multiple user RTS (MU-RTS) frame). As discussed above, the allocations are generally indicated by indicating the corresponding device identifiers. That is, for each RU, the AP can indicate a device identifier (e.g., an association identifier or a MAC address) of the device to which the RU is allocated. In the illustrated example, the AP can indicate that the resource(s) (e.g., RU(s)) are allocated to the group ID of the peer-to-peer group.

At block 535, the AP can then trigger the peer-to-peer communication (and any other communication using resources allocated at block 530). For example, the AP may broadcast a trigger frame that indicates the group ID (triggering the peer-to-peer device(s) in the group to use the resource(s). In some embodiments, the trigger can further include identifiers (e.g., association identifiers or MAC addresses) for other devices (e.g., to trigger uplink communications from these devices to the AP using resources that were allocated to these other devices).

The method 500 then returns to block 525 to continue receiving transmission opportunity requests and generating resource allocations.

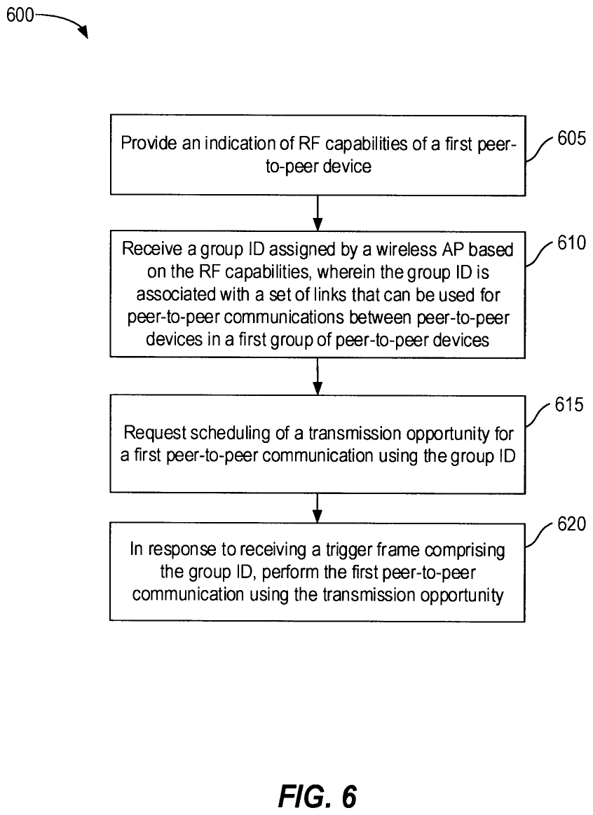

FIG. 6 is a flow diagram depicting an example method 600 for performing peer-to-peer group communications, according to some embodiments of the present disclosure. In some embodiments, the method 600 is performed by a peer-to-peer device, such as a peer-to-peer device 115 of FIG. 1. In some embodiments, the method 600 is performed by a director peer-to-peer device.

At block 605, an indication of RF capabilities (e.g., MLO capability, supported RF frequency bands, and the like) of a first peer-to-peer device (e.g., a peer-to-peer device 115 of FIG. 1) is transmitted.

At block 610, a group ID assigned by a wireless AP (e.g., AP 110 of FIG. 1) based on the RF capabilities is received, where the group ID is associated with a set of links that can be used for peer-to-peer communications between peer-to-peer devices in a first group of peer-to-peer devices.

At block 615, it is requested that the AP schedule of a transmission opportunity for a first peer-to-peer communication is requested using the group ID.

At block 620, in response to receiving a trigger frame comprising the group ID, the first peer-to-peer communication is performed using the transmission opportunity.

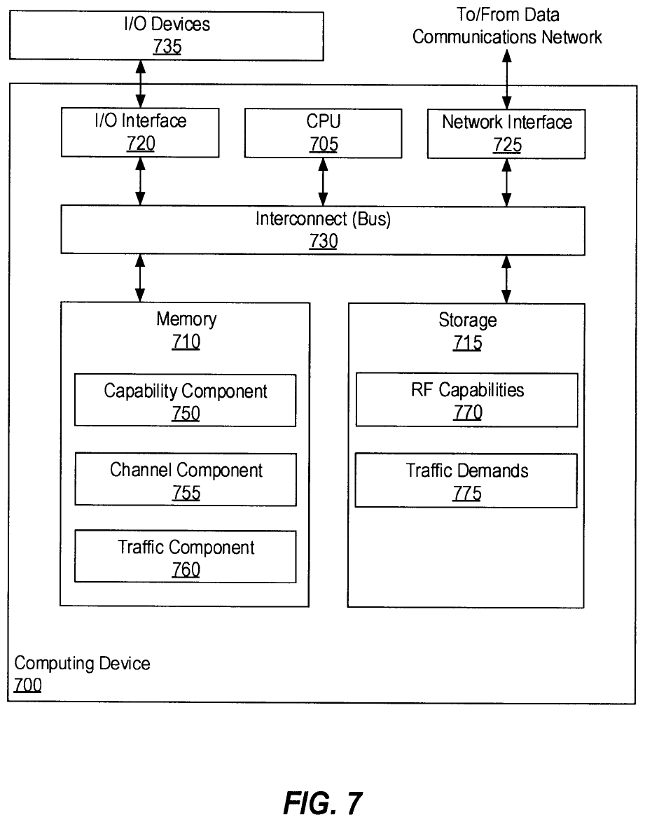

FIG. 7 depicts an example computing device 700 configured to perform various aspects of the present disclosure, according to some embodiments of the present disclosure. Although depicted as a physical device, in embodiments, the computing device 700 may be implemented using virtual device(s), and/or across a number of devices (e.g., in a cloud environment). In one embodiment, the computing device 700 corresponds to a peer-to-peer device, such as peer-to-peer device 115 of FIG. 1. In some embodiments, the computing device corresponds to a director peer-to-peer device for a peer group.

As illustrated, the computing device 700 includes a CPU 705, memory 710, storage 715, a network interface 725, and one or more I/O interfaces 720. In the illustrated embodiment, the CPU 705 retrieves and executes programming instructions stored in memory 710, as well as stores and retrieves application data residing in storage 715. The CPU 705 is generally representative of a single CPU and/or GPU, multiple CPUs and/or GPUs, a single CPU and/or GPU having multiple processing cores, and the like. The memory 710 is generally included to be representative of a random access memory. Storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 735 (such as keyboards, monitors, etc.) are connected via the I/O interface(s) 720. Further, via the network interface 725, the computing device 700 can be communicatively coupled with one or more other devices and components (e.g., via a network, which may include the Internet, local network(s), and the like). As illustrated, the CPU 705, memory 710, storage 715, network interface(s) 725, and I/O interface(s) 720 are communicatively coupled by one or more buses 730.

In the illustrated embodiment, the memory 710 includes a capability component 750, and a channel component 755, and a traffic component 760, which may perform one or more embodiments discussed above. Although depicted as discrete components for conceptual clarity, in embodiments, the operations of the depicted components (and others not illustrated) may be combined or distributed across any number of components. Further, although depicted as software residing in memory 710, in embodiments, the operations of the depicted components (and others not illustrated) may be implemented using hardware, software, or a combination of hardware and software.

In one embodiment, the capability component 750 may receive and aggregate capability information from peers in the peer group, as discussed above. For example, the capability component 750 may determine the RF capabilities of each peer (e.g., their MLO capabilities, their supported channels or bands, and the like). In some embodiments, as discussed above, the capability component 750 can aggregate or summarize these capabilities (e.g., stored in RF capabilities 770). For example, the capability component 750 may determine the type of MLO that each peer supports (e.g., STR, NSTR, eMLSR, and the like).

In some embodiments, the channel component 755 can similarly evaluate/aggregate capability information to select one or more channels or links for the group. For example, the channel component 755 may identify a set of bands or channels that all peers in the group can use, and/or evaluate the identified channels to select one or more channels for the group (e.g., based on channel utilizations, the average or minimum RSSI of each channel for each peer, and the like). The channel component 755 may then request a link set for the selected set of channel(s).

In some embodiments, the traffic component 760 can determine current or future traffic needs or demands of the peer devices in the group, and generate corresponding traffic requests (e.g., requests for peer-to-peer transmission opportunities) from the AP(s). For example, the traffic component 760 may receive explicit indications of traffic (e.g., data amounts, timing, etc.) and/or indications relating to priority (e.g., QoS data) for peer-to-peer communications among the peers. In some embodiments, this information can be stored or maintained in traffic demands 775. In some embodiments, when resources are allocated to the group (using the group ID), the traffic component 760 may similarly determine which peer device(s) in the group should actually use the resources to transmit data.

In the illustrated example, the storage 715 includes RF capabilities 770 of the peer device(s) (e.g., supported MLO types, supported RF bands, and the like) as well as traffic demands 775. Although depicted as residing in storage 715, the RF capabilities 770 and traffic demands 775 may be stored in any suitable location, including memory 710.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
transmitting, by a first peer-to-peer device, an indication of radio frequency (RF) capabilities of the first peer-to-peer device;
receiving, by the first peer-to-peer device, a group ID assigned by a wireless access point (AP) based on RF capabilities of the first peer-to-peer device, wherein the group ID is associated with a set of links that can be used for peer-to-peer communications between peer-to-peer devices in a first group of peer-to-peer devices;
requesting, by the first peer-to-peer device, that the AP schedule a transmission opportunity for a first peer-to-peer communication using the group ID; and
in response to receiving a trigger frame comprising the group ID, performing the first peer-to-peer communication using the transmission opportunity.

2. The method of claim 1, further comprising:
receiving, by the first peer-to-peer device, RF capabilities from one or more peer-to-peer devices in a first group of peer-to-peer devices;
aggregating, by the first peer-to-peer device, the RF capabilities to identify one or more preferred channels for the first group; and
transmitting, by the first peer-to-peer device and to the wireless AP, a request to establish the set of links in the one or more preferred channels.

3. The method of claim 2, wherein aggregating the RF capabilities to identify the one or more preferred channels is based at least in part on at least one of:
(i) channel utilization (CU) of the one or more preferred channels,
(ii) received signal strength indicators (RSSIs) of the one or more preferred channels with respect to the one or more peer-to-peer devices in the first group, or
(iii) accessibility of the one or more preferred channels across multiple wireless APs.

4. The method of claim 2, further comprising receiving one or more indications of traffic demands from the one or more peer-to-peer devices in the first group, wherein allocation of the transmission opportunity is requested based at least in part on the traffic demands from the one or more peer-to-peer devices.

5. The method of claim 1, wherein requesting that the AP schedule the transmission opportunity comprises requesting the transmission opportunity for each link of the set of links.

6. The method of claim 5, wherein requesting that the AP schedule the transmission opportunity further comprises requesting the transmission opportunity for each link of the set of links to have a matching duration based at least in part on determining that one or more peer-to-peer devices in the first group of peer-to-peer devices support non-simultaneous transmit/receive (NSTR) operations.

7. The method of claim 1, wherein requesting that the AP schedule the transmission opportunity comprises requesting scheduling of the transmission opportunity on a preferred link of the set of links based at least in part on determining that one or more peer-to-peer devices in a first group of peer-to-peer devices support enhanced multi-link single-radio (eMLSR) operations.

8. The method of claim 7, wherein the preferred link is selected based on at least one of:
RSSIs of the preferred link with respect to the one or more peer-to-peer devices in the first group, or
CU of the preferred link.

9. The method of claim 1, wherein:
the RF capabilities of the first peer-to-peer device are transmitted to a second peer-to-peer device,
the second peer-to-peer device acts as a director device of a first group of peer-to-peer devices.

10. The method of claim 9, wherein, in response to receiving the RF capabilities of the first peer-to-peer device, the second peer-to-peer device:
aggregates the RF capabilities of the first peer-to-peer device and RF capabilities of one or more other peer-to-peer devices in the first group to identify one or more preferred channels for the first group; and
transmits, to the wireless AP, a request to establish the set of links in the one or more preferred channels.

11. The method of claim 1, wherein:
providing the indication of the RF capabilities of the first peer-to-peer device comprises transmitting the indication of the RF capabilities of the first peer-to-peer device to the wireless AP; and
in response to receiving the indication of the RF capabilities of the first peer-to-peer device, the wireless AP:
assigns the first peer-to-peer device to a first group of peer-to-peer devices based at least in part on the RF capabilities of the first peer-to-peer device,
aggregates the RF capabilities of the first peer-to-peer device and RF capabilities of one or more other peer-to-peer devices in the first group to identify one or more preferred channels for the first group,
establishes the set of links in the one or more preferred channels,
transmits the group ID to each peer-to-peer device in the first group, and
schedules the transmission opportunity using the group ID for the first group.

12. A system, comprising:
one or more computer processors; and
a memory containing a program which when executed by the one or more computer processors performs an operation, the operation comprising:
transmitting, by a first peer-to-peer device, an indication of radio frequency (RF) capabilities of the first peer-to-peer device;
receiving, by the first peer-to-peer device, a group ID assigned by a wireless access point (AP) based on the RF capabilities, wherein the group ID is associated with a set of links that can be used for peer-to-peer communications between peer-to-peer devices in a first group of peer-to-peer devices;
requesting, by the first peer-to-peer device, that the AP schedule a transmission opportunity for a first peer-to-peer communication using the group ID; and
in response to receiving a trigger frame comprising the group ID,
performing the first peer-to-peer communication using the transmission opportunity.

13. The system of claim 12, the operation further comprising:
receiving, by the first peer-to-peer device, RF capabilities from one or more peer-to-peer devices in a first group of peer-to-peer devices;
aggregating, by the first peer-to-peer device, the RF capabilities to identify one or more preferred channels for the first group; and
transmitting, by the first peer-to-peer device and to the wireless AP, a request to establish the set of links in the one or more preferred channels.

14. The system of claim 12, the operation further comprising receiving one or more indications of traffic demands from the one or more peer-to-peer devices in the first group, wherein allocation of the transmission opportunity is requested based at least in part on the traffic demands from the one or more peer-to-peer devices.

15. The system of claim 12, wherein:
the RF capabilities of the first peer-to-peer device are transmitted to a second peer-to-peer device,
the second peer-to-peer device acts as a director device of a first group of peer-to-peer devices.

16. The system of claim 12, wherein:
providing the indication of the RF capabilities of the first peer-to-peer device comprises transmitting the indication of the RF capabilities of the first peer-to-peer device to the wireless AP; and
in response to receiving the indication of the RF capabilities of the first peer-to-peer device, the wireless AP:
assigns the first peer-to-peer device to a first group of peer-to-peer devices based at least in part on the RF capabilities of the first peer-to-peer device,
aggregates the RF capabilities of the first peer-to-peer device and RF capabilities of one or more other peer-to-peer devices in the first group to identify one or more preferred channels for the first group,
establishes the set of links in the one or more preferred channels,
transmits the group ID to each peer-to-peer device in the first group, and
schedules the transmission opportunity using the group ID for the first group.

17. A non-transitory computer-readable medium containing computer program code that, when executed by operation of one or more computer processors, performs an operation comprising:
transmitting, by a first peer-to-peer device, an indication of radio frequency (RF) capabilities of the first peer-to-peer device;
receiving, by the first peer-to-peer device, a group ID assigned by a wireless access point (AP) based on the RF capabilities, wherein the group ID is associated with a set of links that can be used for peer-to-peer communications between peer-to-peer devices in a first group of peer-to-peer devices;
requesting, by the first peer-to-peer device, that the AP schedule a transmission opportunity for a first peer-to-peer communication using the group ID; and
in response to receiving a trigger frame comprising the group ID, performing the first peer-to-peer communication using the transmission opportunity.

18. The non-transitory computer-readable medium of claim 17, the operation further comprising:
receiving, by the first peer-to-peer device, RF capabilities from one or more peer-to-peer devices in a first group of peer-to-peer devices;
aggregating, by the first peer-to-peer device, the RF capabilities to identify one or more preferred channels for the first group; and
transmitting, by the first peer-to-peer device and to the wireless AP, a request to establish the set of links in the one or more preferred channels.

19. The non-transitory computer-readable medium of claim 17, the operation further comprising receiving one or more indications of traffic demands from the one or more peer-to-peer devices in the first group, wherein allocation of the transmission opportunity is requested based at least in part on the traffic demands from the one or more peer-to-peer devices.

20. The non-transitory computer-readable medium of claim 17, wherein:
providing the indication of the RF capabilities of the first peer-to-peer device comprises transmitting the indication of the RF capabilities of the first peer-to-peer device to the wireless AP; and
in response to receiving the indication of the RF capabilities of the first peer-to-peer device, the wireless AP:
assigns the first peer-to-peer device to a first group of peer-to-peer devices based at least in part on the RF capabilities of the first peer-to-peer device,
aggregates the RF capabilities of the first peer-to-peer device and RF capabilities of one or more other peer-to-peer devices in the first group to identify one or more preferred channels for the first group,
establishes the set of links in the one or more preferred channels,
transmits the group ID to each peer-to-peer device in the first group, and
schedules the transmission opportunity using the group ID for the first group.
